(19) United States
(12) Patent Application Publication
(10) Pub. No.: US 2026/0144266 A1
(43) Pub. Date: May 28, 2026

(54) METHODS OF TREATING PLANT-BASED PRODUCTS TO REDUCE MICROBE PROLIFERATION AND EXTEND SHELF LIFE

(71) Applicant: Ascribe Bioscience Inc., Ithaca, NY (US)

(72) Inventors: Jay Farmer, Ithaca, NY (US); Gabriel Wilmoth, Chapel Hill, NC (US)

(21) Appl. No.: 18/854,175

(22) PCT Filed: Apr. 7, 2023
(86) PCT No.: PCT/US23/17947

§ 371 Date: Oct. 4, 2024

Related U.S. Application Data
(60) Provisional application No. 63/328,596, filed on Apr. 7, 2022.

(51) Int. Cl. A23B 7/154

(52) U.S. Cl. CPC A23B 7/154

(57) ABSTRACT

This application relates to methods of inhibiting the growth of microbes in and/or on plant-based products by treating the plant-based products with a composition including one or more ascarosides.

### PRIORITY CLAIM

This application claims priority to U.S. Provisional Patent Application Ser. No. 63/328,596 entitled “Methods of Treating Plant-Based Products to Reduce Microbe Proliferation and Extend Shelf Life” filed on Apr. 7, 2022, which is incorporated herein by reference.

### FIELD OF THE INVENTION

This application generally relates to methods of reducing foodborne illness and/or extending the shelf life of plant-based products. More specifically, the invention provides methods of treating fruits, vegetables, and other products obtained from plants, to reduce or prevent microbial growth and/or to slow spoilage of these items.

### BACKGROUND OF THE INVENTION

Fruits, vegetables and plants are susceptible to many different types of contamination which can occur at any time from before harvest, during harvest, through the time the produce reaches the consumers (and beyond). After harvesting, most fruits and vegetables are washed to remove dirt and pesticide residue. For fruits and vegetables, dump tanks (containers filled with water) can be used to collect the produce during crop harvesting. The water is used to simultaneously clean the produce and inhibit bruising of the product. Other fruits, vegetables, and plants can be washed after harvesting using various spray washing techniques or baths.

However, if improper harvesting or washing techniques are used, the chance of contamination of the produce is increased. Many fruits and vegetables are harvested by hand by harvest workers. However, improper hygiene practices by harvest workers, or workers who are harvesting while infected with communicable diseases are also sources of bacterial contamination. Reuse or improper emptying of the water used in dump tanks can also lead to the buildup of infectious disease pathogens in the water used to collect the produce.

To mitigate these potential problems, extensive post-harvest washing with various chemical treatments are commonly used to reduce microbial contamination. For example, treatments with electrolyzed water, organic acids, calcium hypochlorite, or sodium hypochlorite (bleach) are routinely used to minimize microbial contamination. While generally effective, chemicals such as calcium and sodium hypochlorite are toxic by oral and dermal routes and their solutions can release toxic gases, potentially putting workers at risk. Worse still, these chemicals are strong oxidizing and halogenating agents and may degrade the nutritive value of plants and contaminate them with residual chlorinated organic molecules formed during treatment. It would be beneficial to provide further methods to ensure the safety of fruits and vegetables.

### SUMMARY OF THE INVENTION

Compositions and methods for inhibiting microbial growth in and/or on plant based products are provided.

In an embodiment, a method of inhibiting microbial growth in and/or on plant-based products comprises treating the plant-based products with a composition comprising one or more ascarosides, wherein the treated plant-based products are resistant to microbial growth. The microbial growth that is inhibited can be growth of human pathogenic microbes. Other microbial growth that can be inhibited includes bacterial growth, fungal growth and mold growth.

In an embodiment, the microbial growth that is inhibited is microbial growth associated with spoilage of the plant-based products.

In an embodiment, a method of extending the shelf life of plant-based products, comprises treating the produce after harvest with a composition comprising one or more ascarosides.

In an embodiment, a method of extending the shelf life of plant-based products, comprises treating the produce prior to harvest with a composition comprising one or more ascarosides.

In an embodiment, a method of extending the shelf life of vegetables, comprises treating the vegetables with a composition comprising one or more ascarosides.

In an embodiment, a method of extending the shelf life of fruit, comprises treating the fruit with a composition comprising one or more ascarosides.

In an embodiment, a method of extending the shelf life of plant-based material, comprises continuously contacting the plan material with a composition comprising one or more ascarosides during shipping, marketing or during use by a consumer. For example, by keeping the stems of cut flowers, decorative foliage or herbs submersed in a solution containing ascaroside, or by keeping the stems or other parts of cut flowers, decorative foliage or herbs in contact with an absorptive material moistened with a solution containing ascarosides. In another embodiment, an ascaroside composition may be provided packaged with decorative plant material for use by a consumer, for example by adding the ascaroside composition to vase water. In certain embodiments, the ascaroside can be incorporated into a nutrient composition containing sugar or similar materials which is designed to enhance the vase-life of cut flowers and foliage.

Methods of treating plant-based products with a composition comprising one or more ascarosides include, e.g., soaking, spraying, or dip-coating the plant-based products. Treatment of plant-based products with a composition comprising one or more ascarosides prevents or inhibits microbial growth in and/or on the plant-based products.

Plant based products include products that are produced by a plant (e.g., fruits and vegetables), or which are obtained by harvesting all or a portion of the plant (e.g., lettuce, sprouts, flowers, and grasses).

Exemplary vegetables that can be treated according to the methods of the present disclosure include, but are not limited to, stem-based vegetables, leaf-based vegetables, flower-based vegetables, roots/tuber-based vegetables, bulb-based vegetables, fruit-based vegetables, and seed-based vegetables.

Exemplary fruits that can be treated according to the methods of the present disclosure include, but are not limited to, berries, citrus fruits, drupes, pomes, melons, and tropical fruit.

Exemplary non-food plant materials that can be treated according to the methods of the present disclosure include, but are not limited to, cut flowers, corsages, decorative foliage, Christmas trees, garlands, and the like.

In an embodiment, the one or more ascarosides conform to formula I.

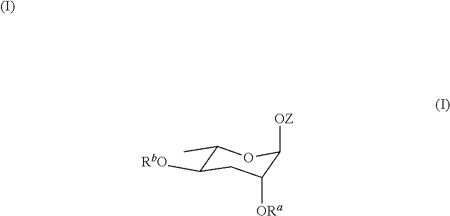

where:
Z is an optionally substituted C₂₋₁₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. —a moiety —C(O)OR^{c}), a C₂₋₂₀ carbamate (e.g. —a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R)₂), a sugar moiety, a peptide, a polymer chain, or a linkage via a bond or a carbon-containing linker moiety to another ascaroside molecule. Where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

In an embodiment, the one or more ascarosides conform to formula I

where Z is:
(i) —CH(CH₃)—R¹, where R¹ is an optionally substituted C₁₋₄₀ aliphatic group;
(ii) —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iii) —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iv) —CH(CH₃)—(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(v) —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vi) —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vii) —(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(viii) —(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; or
(ix) —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule.

In an embodiment, the one or more ascarosides conform to formula I.

where R^{a} and R^{b} are each —H; and
where Z is:
(x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xii) —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiii) —CH(CH₃)—(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xvi) —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
(xvii) —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.

In a particular embodiment, for ascarosides of formula I, Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide. A specific example of this type of ascaroside is ascr #18, shown below.

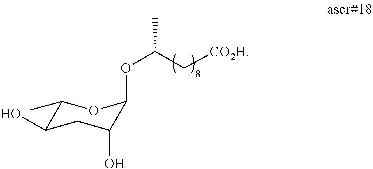

In a particular embodiment, the one or more ascarosides have formula I, wherein Z is —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide. A specific example of this type of ascaroside is ascr #7, shown below.

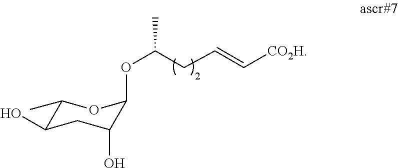

In an embodiment, plant-based products are treated with an aqueous solution comprising one or more ascarosides. In an embodiment, the plant-based products are treated by soaking the plant-based products in a composition comprising one or more ascarosides. In a specific embodiment, the plant-based products are soaked in a tank containing the composition comprising one or more ascarosides during harvesting of the plant-based products. In another embodiment, the plant-based products are treated by spraying the plant-based products with a composition comprising one or more ascarosides.

In one embodiment, the plant-based products are soaked in the aqueous solution for a time of about 1 min to about 6 hours. The concentration of the one or more ascarosides in the aqueous solution may be about 1 ppb to about 100 ppm.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present disclosure will become apparent from the following.

### Definitions

For the present disclosure to be more readily understood, certain terms are first defined below. Additional definitions for the following terms and other terms are set forth throughout the specification.

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18 00 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain compounds provided herein can comprise one or more asymmetric centers, and thus can exist in various stereoisomeric forms, e.g., enantiomers and/or diastereomers. Thus, inventive compounds and compositions thereof may be in the form of an individual enantiomer, diastereomer or geometric isomer, or may be in the form of a mixture of stereoisomers. In certain embodiments, the compounds of the invention are enantiopure compounds. In certain other embodiments, mixtures of enantiomers or diastereomers are provided.

Furthermore, certain compounds as described herein may have one or more double bonds that can exist as either a Z or E isomer, unless otherwise indicated. The compounds can be provided as individual isomers substantially free of other isomers and alternatively, as mixtures of various isomers, e.g., racemic mixtures of enantiomers.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the invention. For instance, a compound may, in some embodiments, be provided substantially free of one or more corresponding stereoisomers, and may also be referred to as “stereochemically enriched.”

Where a particular enantiomer is preferred, it may, in some embodiments be provided substantially free of the opposite enantiomer, and may also be referred to as “optically enriched.” “Optically enriched,” as used herein, means that the compound is made up of a significantly greater proportion of one enantiomer. In certain embodiments the compound is made up of at least about 90% by weight of an enantiomer. In some embodiments the compound is made up of at least about 95%, 97%, 98%, 99%, 99.5%, 99.7%, 99.8%, or 99.9% by weight of an enantiomer. In some embodiments the enantiomeric excess of provided compounds is at least about 90%, 95%, 97%, 98%, 99%. 99.5%, 99.7%, 99.8%, or 99.9%. In some embodiments, enantiomers may be isolated from racemic mixtures by any method known to those skilled in the art, including chiral high pressure liquid chromatography (HPLC) and the formation and crystallization of chiral salts or prepared by asymmetric syntheses. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, NY, 1962); Wilen, S. H. Tables of Resolving Agents and Optical Resolutions p. 268 (E. L. Eliel, Ed., Univ. of Notre Dame Press, Notre Dame, IN 1972).

The terms “halo” and “halogen” as used herein refer to an atom selected from fluorine (fluoro, —F), chlorine (chloro, —Cl), bromine (bromo, —Br), and iodine (iodo, —I).

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-30 carbon atoms. In certain embodiments, aliphatic groups contain 1-12 carbon atoms. In certain embodiments, aliphatic groups contain 1-8 carbon atoms. In certain embodiments, aliphatic groups contain 1-6 carbon atoms. In some embodiments, aliphatic groups contain 1-5 carbon atoms, in some embodiments, aliphatic groups contain 1-4 carbon atoms, in yet other embodiments aliphatic groups contain 1-3 carbon atoms, and in yet other embodiments aliphatic groups contain 1-2 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic” or “heteroaliphatic group”, as used herein, denotes an aliphatic group where one or more carbon or hydrogen atoms are replaced by a heteroatom (e.g. oxygen, nitrogen, sulfur, phosphorous, boron, etc.).

The term “unsaturated”, as used herein, means that a moiety has one or more double or triple bonds.

The term “alkyl,” as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-12 carbon atoms. In certain embodiments, alkyl groups contain 1-8 carbon atoms. In certain embodiments, alkyl groups contain 1-6 carbon atoms. In some embodiments, alkyl groups contain 1-5 carbon atoms, in some embodiments, alkyl groups contain 1-4 carbon atoms, in yet other embodiments alkyl groups contain 1-3 carbon atoms, and in yet other embodiments alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “alkenyl,” as used herein, denotes a monovalent group derived from a straight- or branched-chain aliphatic moiety having at least one carbon-carbon double bond by the removal of a single hydrogen atom. Unless otherwise specified, alkenyl groups contain 2-12 carbon atoms. In certain embodiments, alkenyl groups contain 2-8 carbon atoms. In certain embodiments, alkenyl groups contain 2-6 carbon atoms. In some embodiments, alkenyl groups contain 2-5 carbon atoms, in some embodiments, alkenyl groups contain 2-4 carbon atoms, in yet other embodiments alkenyl groups contain 2-3 carbon atoms, and in yet other embodiments alkenyl groups contain 2 carbon atoms. Alkenyl groups include, for example, ethenyl, propenyl, butenyl, 1-methyl-2-buten-1-yl, and the like.

The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring”. In certain embodiments of the present invention, “aryl” refers to an aromatic ring system which includes, but is not limited to, phenyl, biphenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, or tetrahydronaphthyl, and the like.

As described herein, compounds of the invention may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned are preferably those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

Suitable monovalent substituents on a substitutable carbon atom of an “optionally substituted” group are independently halogen; —(CH₂)₀₋₄R^{o}; —(CH₂)₀₋₄OR^{o}; —O—(CH₂)₀₋₄C(O)OR^{o}; —(CH₂)₀₋₄CH(OR^{o})₂; —(CH₂)₀₋₄SR^{o}; —(CH₂)₀₋₄Ph, which may be substituted with R^{o}; —(CH₂)₀₋₄O(CH₂)₀₋₁Ph which may be substituted with R^{o}; —CH═CHPh, which may be substituted with R^{o}; —NO₂; —CN; —N₃; —(CH₂)₀₋₄N(R^{o})₂; —(CH₂)₀₋₄N(R^{o})C(O)R^{o}; —N(R^{o})C(S)R^{o}; —(CH₂)₀₋₄N(R^{o})C(O)NR^{o}₂; —N(R^{o})C(S)NR^{o}₂; —(CH₂)₀₋₄N(R^{o})C(O)OR^{o}; —N(R^{o})N(R^{o})C(O)R^{o}; —N(R^{o})N(R^{o})C(O)NR^{o}₂; —N(R^{o})N(R^{o})C(O)OR^{o}; —(CH₂)₀₋₄C(O)R^{o}; —C(S)R^{o}; —(CH₂)₀₋₄C(O)OR^{o}; —(CH₂)₀₋₄C(O)N(R^{o})₂; —(CH₂)₀₋₄C(O)SR^{o}; —(CH₂)₀₋₄C(O)OSiR^{o}₃; —(CH₂)₀₋₄OC(O)R^{o}; —OC(O)(CH₂)₀₋₄SR—, SC(S)SR^{o}; —(CH₂)₀₋₄SC(O)R^{o}; —(CH₂)₀₋₄C(O)NR^{o}₂; —C(S)NR^{o}₂; —C(S)SR^{o}; —SC(S)SR^{o}, —(CH₂)₀₋₄OC(O)NR^{o}₂; —C(O)N(OR^{o})R^{o}; —C(O)C(O)R^{o}; —C(O)CH₂C(O)R^{o}; —C(NOR^{o})R^{o}; —(CH₂)₀₋₄SSR^{o}; —(CH₂)₀₋₄S(O)₂R^{o}; —(CH₂)₀₋₄S(O)₂OR^{o}; —(CH₂)₀₋₄OS(O)₂R^{o}; —S(O)₂NR^{o}₂; —(CH₂)₀₋₄S(O)R^{o}; —N(R^{o})S(O)₂NR^{o}₂; —N(R^{o})S(O)₂R^{o}; —N(OR^{o})R^{o}; —C(NH)NR^{o}₂; —P(O)₂R^{o}; —P(O)R^{o}₂; —OP(O)R^{o}₂; —OP(O)(OR^{o})₂; SiR^{o}₃; —(C₁₋₄ straight or branched alkylene)O—N(R^{o})₂; or —(C₁₋₄ straight or branched alkylene)C(O)O—N(R^{o})₂, wherein each R^{o} may be substituted as defined below and is independently hydrogen, C₁₋₈ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur, or, notwithstanding the definition above, two independent occurrences of R^{o}, taken together with their intervening atom(s), form a 3-12-membered saturated, partially unsaturated, or aryl mono- or polycyclic ring having 0-4 heteroatoms independently selected from nitrogen, oxygen, or sulfur, which may be substituted as defined below.

Suitable monovalent substituents on R^{o} (or the ring formed by taking two independent occurrences of R^{o} together with their intervening atoms), are independently halogen, —(CH₂)₀₋₂R^{•}, -(haloR^{•}), —(CH₂)₀₋₂OH, —(CH₂)₀₋₂OR^{•}, —(CH₂)₀₋₂CH(OR^{•})₂; —O(haloR^{•}), —CN, —N₃, —(CH₂)₀₋₂C(O)R^{•}, —(CH₂)₀₋₂C(O)OH, —(CH₂)₀₋₂C(O)OR^{•}, —(CH₂)₀₋₄C(O)N(R^{o})₂; —(CH₂)₀₋₂SR^{•}, —(CH₂)₀₋₂SH, —(CH₂)₀₋₂NH₂, —(CH₂)₀₋₂NHR^{•}, —(CH₂)₀₋₂NR^{•}₂, —NO₂, —SiR^{•}₃, —OSiR^{•}₃, —C(O)SR^{•}, —(C₁₋₄ straight or branched alkylene)C(O)OR^{•}, or —SSR^{•} wherein each R^{•} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{o} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, ═NR*, ═NOR*, —O(C(R*₂))₂₋₃O—, or —S(C(R*₂))₂₋₃S—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{•}, -(haloR^{•}), —OH, —OR, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

As used herein, the term “substantially” refers to the qualitative condition of exhibiting total or near-total extent or degree of a characteristic or property of interest.

The convention of naming ascarosides by a several-letter prefix followed by a pound sign (#) and a number is sometimes used (for example ascr #18). This convention is used in the scientific literature and the skilled artisan will understand that each such name is associated with a specific chemical structure of known composition and will readily apprehend the structure of the molecule referred to using this naming convention. Unless otherwise indicated, all compound identifiers of this format used herein conform to the definitions described in the C. elegans Small Molecule Identifier Database (SMID-DB) maintained at http://www.smid-db.org.

### BRIEF DESCRIPTION OF THE DRAWINGS

In the drawings, the features are not necessarily represented to scale, emphasis instead generally being placed upon illustrating the principles of the disclosed compositions and methods and are not intended as limiting. For purposes of clarity, not every component may be labeled in the drawing. In the following description, various embodiments are described with reference to the following drawings, in which:

FIG. 1A is a graph showing the change in weight for strawberries treated with an ascaroside composition vs. untreated strawberries; and

FIG. 1B are pictures showing the change in appearance for strawberries treated with an ascaroside composition vs. untreated strawberries.

### DETAILED DESCRIPTION OF THE INVENTION

Spoilage of many plant-based products can be caused by damage caused by microbes such as bacteria, fungi, molds and viruses, although other processes such as over-ripening or bruising can also cause spoilage of plant-based products. Microbes speed deterioration of plant-based products through structural decay. Microorganisms such as bacteria, fungi and molds release enzymes as they grow that speed up the spoiling process. Additionally, some microbial growth in and/or on plant-based products can cause foodborne illnesses in a person who ingests the contaminated plant-based products.

As used herein the term “microbes” refers to bacteria, fungi, viruses, parasites, and/or oomycetes. As used herein the term “microbial growth” refers to the growth of microbes in and/or on the plant-based products. As used herein the term “pathogen” refers to a microbe that causes a disease. As used herein the term “human pathogen” is a pathogen that causes a disease in humans.

Compositions and methods for inhibiting microbial growth in and/or on plant-based products are provided. Compositions comprise at least one ascaroside. Additional optional components can include agriculturally acceptable carriers and components to enhance inhibition of microbial growth or proliferation. Methods of treating the plant-based products with a composition comprising one or more ascarosides include soaking, spraying, or dip-coating the plant-based products. Treatment of plant-based products with a composition comprising one or more ascarosides prevents or inhibits microbial growth on and/or inside the plant-based products.

As used herein the term “plant-based products” refer to products that are produced by a plant (e.g., fruits), or which are obtained by harvesting all or a portion of the plant (e.g., vegetables, sprouts, flowers, and grasses). As used herein, the term “produce” refers to edible products obtained from plants. Typical produce includes fruits and vegetables.

The compositions and methods of the invention inhibit the growth and/or proliferation of microbes on plant-based products, particularly food borne human pathogens. In some embodiments, the microbes include human pathogens such as viruses, bacteria, fungi, parasites, and/or oomycetes. Representative food pathogens include bacteria that cause illnesses such as Salmonella, Clostridium perfringens, Campylobacter, Staphylococcus aureus (Staph), Escherichia coli, Listeria, and the like. In some embodiments, the microbes include bacteria, fungi, and/or oomycetes that cause food spoilage.

Plant-based products that can be treated with a composition comprising at least one ascaroside include, but are not limited to fruits, vegetables, lettuce, sprouts, flowers, grasses, and products made from these items.

Exemplary vegetables that can be treated according to the methods of the present disclosure include, but are not limited to, stem-based vegetables (e.g., asparagus, kohlrabi), leaf-based vegetables (e.g., spinach, lettuce, kale, cabbage), flower or bud-based vegetables (e.g., cauliflower, broccoli, artichoke), root/tuber-based vegetables (e.g., carrots, radishes, turnips, beets, potatoes, sweet potatoes), bulb-based vegetables (e.g., onions, garlic, leeks, fennel), fruit-based vegetables (e.g., tomatoes, cucumbers, eggplant, zucchini, squash, pumpkin), and seed-based vegetables (e.g., green beans, french beans, butter beans, peas, corn). Exemplary fruits that can be treated according to the methods of the present disclosure include, but are not limited to, berries (e.g., blueberries, raspberries, blackberries, strawberries, grapes), citrus fruits (e.g., oranges, lemons, limes, grapefruit, mandarins, kumquats), drupes (e.g., peaches, avocados, cherries, mangoes, plums, nectarines), pomes (e.g., apples, pears), melons (e.g., watermelons, cantaloupe, casaba, honeydew), and tropical fruit (e.g., bananas, guavas, papayas, pomegrantes, kiwi, pineapple).

In one aspect, the present disclosure provides a method of inhibiting the proliferation of microbes in and/or on a vegetable. The method comprises treating the vegetable with a composition comprising one or more ascarosides. In certain embodiments, vegetables treated with a composition comprising one or more ascarosides are characterized in that they are more resistant to the proliferation of microbes upon and/or within their tissues relative to untreated vegetables.

In one aspect, the present disclosure provides a method of inhibiting the proliferation of microbes in and/or on a fruit. The method comprises treating the fruit with a composition comprising one or more ascarosides. In certain embodiments, fruit treated with a composition comprising one or more ascarosides are characterized in that they are more resistant to the proliferation of microbes upon and/or within their tissues relative to untreated fruits.

Ascarosides are secondary metabolites produced by nematodes. A large number of structurally diverse ascaroside structures have been identified in nature and the molecules are believed to function as an evolutionarily conserved chemical language used by nematodes to control many aspects of their development. Ascarosides are also perceived by other organisms and have been demonstrated to have a range of effects on numerous organisms including: bacteria, fungi, plants, and mammals including humans. In the present disclosure, the application of ascarosides to plant-based products is shown to activate and prime plant defenses, conferring protection against colonization and/or proliferation by non-plant microbes. Such protection includes preventing microbe proliferation within tissues of the plants and products of the plants (e.g., fruits and vegetables). The methods of the disclosure to stimulate the plant's innate defense systems are a unique tool, e.g., to combat microbes that have infiltrated the plant. Once stimulated by the compositions disclosed herein, the defense responses in the treated plants and plant products protect against pathogens for a given period of time, e.g., on the order of several weeks.

Ascarosides are derivatives of the sugar ascarylose—a di-deoxy sugar lacking hydroxyl groups at its 3- and 6-positions. Ascarosides have the general structure shown in Formula I:

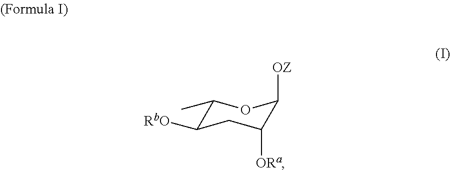

wherein:
Z is an optionally substituted C₂₋₁₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. —a moiety —C(O)OR^{c}), a C₂₋₂₀ carbamate (e.g. —a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule. Where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

In certain embodiments, Z is:
(i) —CH(CH₃)—R¹, where R¹ is an optionally substituted C₁₋₄₀ aliphatic group
(ii) —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iii) —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iv) —CH(CH₃)—(CH₂)ₙ—CH(OH)—CH—CO₂R³², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(v) —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vi) —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vii) —(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(viii) —(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; or
(ix) —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule.

In certain embodiments, Z is:
(x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xii) —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiii) —CH(CH₃)—(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xvi) —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
(xvii) —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.

In certain embodiments, R^{a} is —H.

In certain embodiments R^{b} is —H.

In certain embodiments, R^{a} and R^{b} are the same. In certain embodiments R^{a} and R^{b} are both —H.

In certain embodiments, R^{a} and R^{b} are different. In certain embodiments, R^{a} is —H, and R^{b} is other than —H. In certain embodiments, R^{a} is other than —H and R^{b} is —H. In certain embodiments, R^{a} is —H and R^{b} is p-hydroxybenzoate. In certain embodiments, R^{a} is —H and R^{b} is indole-3-carboxylate. In certain embodiments, R^{a} is —H and R^{b} is (E)-2-methyl-2-butenoate. In certain embodiments, R^{a} is —H and R^{b} is picolinate. In certain embodiments, R^{a} is —H and R^{b} is nicotinate. In certain embodiments, R^{a} is —H and R^{b} is (R)-2-hydroxy-2-(4-hydroxyphenyl)ethyl)amino)-4-oxobutanoate. In certain embodiments, R^{a} is —H and R^{b} is 4-((4-hydroxyphenethyl)amino)-4-oxobutanoate.

In certain embodiments R^{a} and R^{b} are both —H, and Z is selected from the formulae defined in (i) to (ix) above. In certain embodiments R^{a} and R^{b} are both —H, and Z conforms to formula (i) above. In certain embodiments R^{a} and R^{b} are both —H, and Z conforms to formula (ii) above. In certain embodiments R^{a} and R^{b} are both —H, and Z conforms to formula (iii) above. In certain embodiments R^{a} and R^{b} are both —H, and Z conforms to formula (iv) above. In certain embodiments R^{a} and R^{b} are both —H, and Z conforms to formula (v) above. In certain embodiments R^{a} and R^{b} are both —H, and Z conforms to formula (vi) above. In certain embodiments R^{a} and R^{b} are both —H, and Z conforms to formula (vii) above. In certain embodiments R^{a} and R^{b} are both —H, and Z conforms to formula (viii) above. In certain embodiments R^{a} and R^{b} are both —H, and Z conforms to formula (ix) above. In certain embodiments R^{a} and R^{b} are both —H, and Z conforms to formula (x) above. In certain embodiments R^{a} and R^{b} are both —H, and Z conforms to formula (xi) above. In certain embodiments R^{a} and R^{b} are both —H, and Z conforms to formula (xii) above. In certain embodiments R^{a} and R^{b} are both —H, and Z conforms to formula (xiii) above. In certain embodiments R^{a} and R^{b} are both —H, and Z conforms to formula (xiv) above. In certain embodiments R^{a} and R^{b} are both —H, and Z conforms to formula (xv) above. In certain embodiments R^{a} and R^{b} are both —H, and Z conforms to formula (xvi) above. In certain embodiments R^{a} and R^{b} are both —H, and Z conforms to formula (xvii) above.

In certain embodiments, R² is —H. In certain embodiments, R² is a metal cation. In certain embodiments, R² is an organic cation (e.g. a nitrogen or phosphorous centered cationic group). In certain embodiments, R² is an optionally substituted C₁₋₂₀ aliphatic group. In certain embodiments, R² is an optionally substituted C₁₋₁₂ aliphatic group. In certain embodiments, R² is an optionally substituted C₁₋₈ aliphatic group. In certain embodiments, R² is an optionally substituted C₁₋₆ aliphatic group. In certain embodiments, R² is selected from methyl, ethyl, n-propyl, i-propyl, n-butyl, sec-butyl, and t-butyl. In certain embodiments, R² is an optionally substituted aromatic group. In certain embodiments, R² is a glycoside. In certain embodiments, R² comprises an amino acid. In certain embodiments, R² comprises a peptide. In certain embodiments, R² comprises a nucleotide.

In certain embodiments, at least one R³ is —H. In certain embodiments, both R³ groups are —H. In certain embodiments, at least one R³ is an optionally substituted C₁₋₂₀ aliphatic group. In certain embodiments, both R³ groups are an optionally substituted C₁₋₂₀ aliphatic group which may be the same or different. In certain embodiments, at least one R³ is an optionally substituted C₁₋₁₂ aliphatic group. In certain embodiments, at least one R³ is an optionally substituted C₁₋₈ aliphatic group. In certain embodiments, at least one R³ is an optionally substituted C₁₋₆ aliphatic group. In certain embodiments, at least one R³ is selected from methyl, ethyl, n-propyl, i-propyl, n-butyl, sec-butyl, and t-butyl. In certain embodiments, at least one R³ is —CH₂CH₂OH. In certain embodiments, at least one R³ is —CH₂CH₂OR². where R² is as defined in the genera and subgenera herein. In certain embodiments, at least one R³ is an optionally substituted aromatic group. In certain embodiments, at least one R³ comprises a glycoside. In certain embodiments, at least one R³ comprises an amino acid. In certain embodiments, at least one R³ at least one R³ comprises a peptide. In certain embodiments, at least one R³ comprises a nucleotide.

In certain embodiments, an ascaroside is selected from the group consisting of

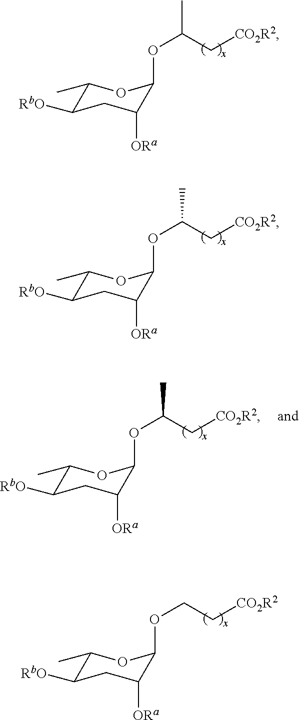

where x is an integer from 1 to 22, and each of R^{a}, R^{b}, and R² is as defined above and in the genera and subgenera herein.

In certain embodiments, an ascaroside is selected from the group consisting of

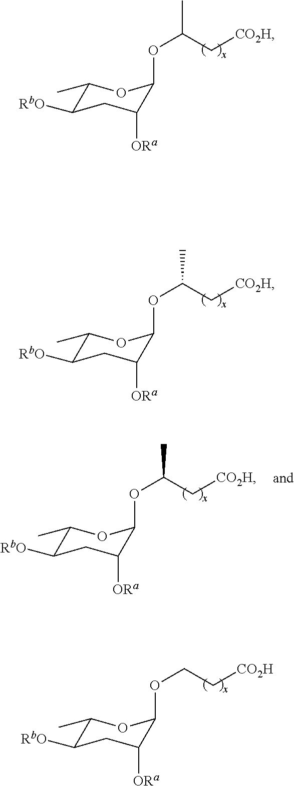

Where each of x, R^{a}, and R^{b}, is as defined above and in the genera and subgenera herein.

In certain embodiments, an ascaroside is selected from the group consisting of

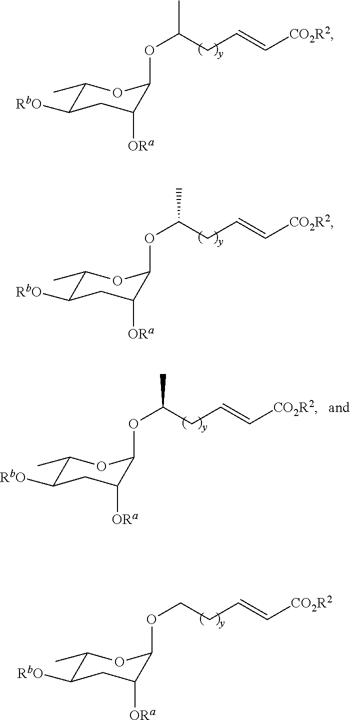

where y is an integer from 1 to 20, and each of R^{a}, R^{b}, and R² is as defined above and in the genera and subgenera herein.

In certain embodiments, an ascaroside is selected from the group consisting of:

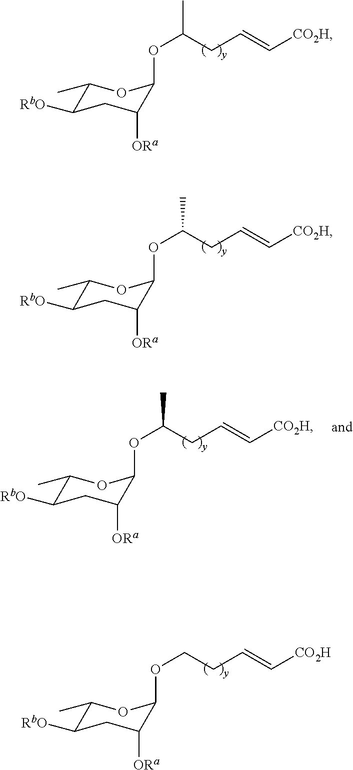

where each of y, R^{a}, and R^{b}, is as defined above and in the genera and subgenera herein.

In certain embodiments, an ascaroside is selected from the group consisting of:

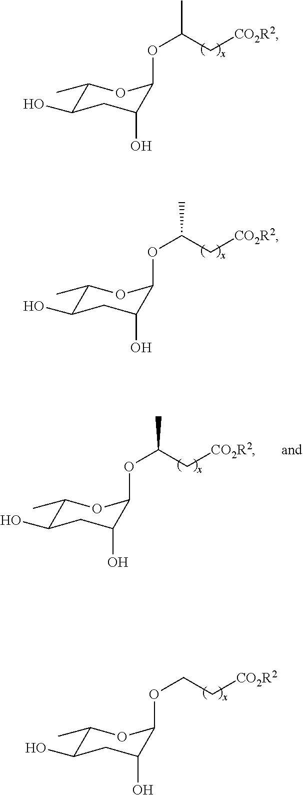

where x is an integer from 1 to 22, and R² is as defined above and in the genera and subgenera herein.

In certain embodiments, an ascaroside is selected from the group consisting of:

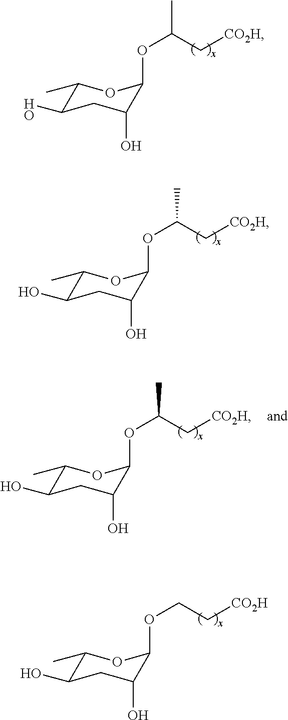

where x is as defined above and in the genera and subgenera herein.

In certain embodiments, an ascaroside is selected from the group consisting of:

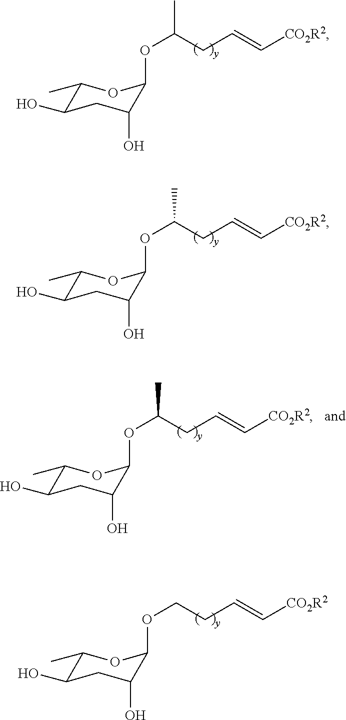

where y is an integer from 1 to 20, and R² is as defined above and in the genera and subgenera herein.

In certain embodiments, an ascaroside is selected from the group consisting of:

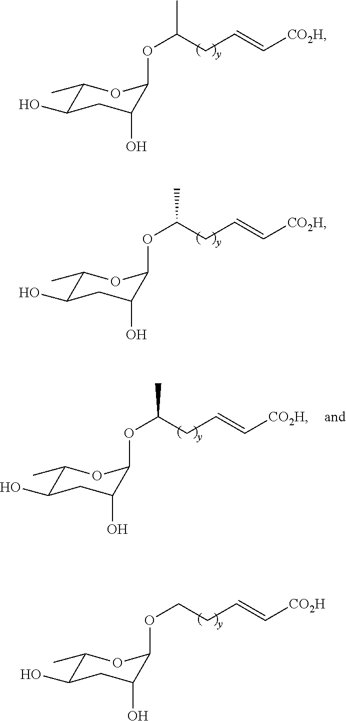

where y is as defined above and in the genera and subgenera herein.

In certain embodiments, an ascaroside is selected from the group consisting of

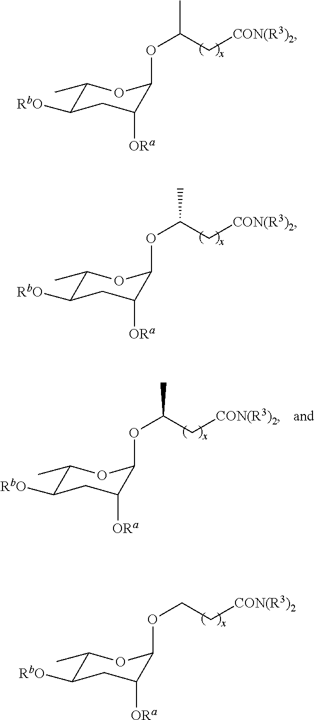

where x is an integer from 1 to 22, and each of R^{a}, R^{b}, and R³ is as defined above and in the genera and subgenera herein.

In certain embodiments, an ascaroside is selected from the group consisting of

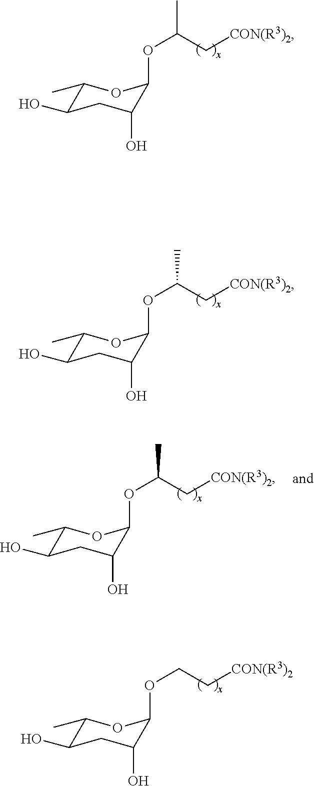

where each of x and R³ is as defined above and in the genera and subgenera herein.

In certain embodiments, an ascaroside is selected from the group consisting of

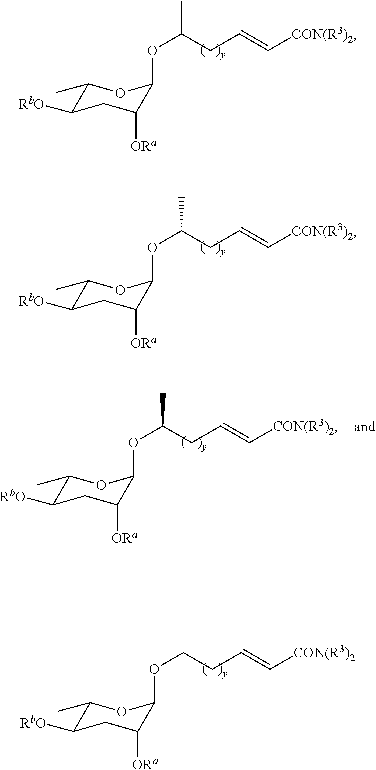

where y is an integer from 1 to 20, and each of R^{a}, R^{b}, and R² is as defined above and in the genera and subgenera herein.

In certain embodiments, an ascaroside is selected from the group consisting of

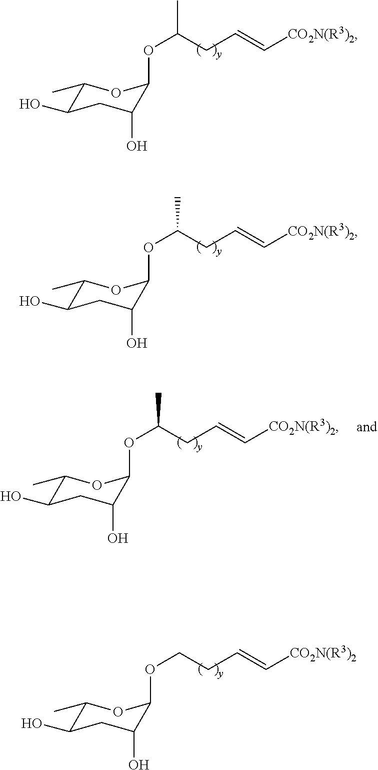

where each of y and R³ is as defined above and in the genera and subgenera herein.

In an embodiment, ascarosides useful in the context of the present disclosure have the general structure (I), where Z is —CH(CH₃)—(CH₂)ₙ—C₀₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide, and can be used for inhibiting human pathogenic bacterial growth in or on a plant.

In an embodiment, ascarosides useful in the context of the present disclosure have the general structure (I) where Z is —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

In certain embodiments, x in any of the structures herein is an integer between 2 and 18 inclusive. In certain embodiments, x in any of the structures herein is an integer between 4 and 10 inclusive. In certain embodiments, x in any of the structures herein is an integer between 6 and 12 inclusive. In certain embodiments, x in any of the structures herein is an integer between 5 and 9 inclusive. In certain embodiments, x in any of the structures herein is 7, 8 or 9. In certain embodiments, x in any of the structures herein is 6. In certain embodiments, x in any of the structures herein is 7. In certain embodiments, x in any of the structures herein is 8. In certain embodiments, x in any of the structures herein is 9. In certain embodiments, x in any of the structures herein is 10. In certain embodiments, x in any of the structures herein is 11. In certain embodiments, x in any of the structures herein is 12.

In certain embodiments, x in any of the structures herein is an integer greater than 5. In certain embodiments, x in any of the structures herein is an integer greater than 6, greater than 7, greater than 9, or greater than 10. In certain embodiments, x in any of the structures herein is an integer between 10 and 20.

In certain embodiments, provided ascaroside compositions comprise a mixture of ascarosides varying only in the value of x (i.e. the composition comprises a mixture of congeners with varying sidechain lengths). In certain embodiments, such compositions are characterized in that the average value of x in the composition is between about 2 and about 20). In certain embodiments, such compositions are characterized in that the average value of x in the composition is between about 3 and about 10, between about 4 and about 12, between about 6 and about 10, or between about 7 and about 9. In certain embodiments, such compositions are characterized in that the average value of x in the composition is greater than about 4, greater than about 5, greater than about 6, greater than about 7, or greater than about 8. The average value of x in such compositions can be determined by various methods well known in the art including, but not limited to analyzing the mixture by ¹H NMR spectroscopy, mass spectroscopy, high performance liquid chromatography and the like.

In certain embodiments, y in any of the structures herein is an integer between 2 and 18 inclusive. In certain embodiments, y in any of the structures herein is an integer between 4 and 10 inclusive. In certain embodiments, y in any of the structures herein is an integer between 6 and 12 inclusive. In certain embodiments, y in any of the structures herein is an integer between 5 and 9 inclusive. In certain embodiments, y in any of the structures herein is 7, 8 or 9. In certain embodiments, y in any of the structures herein is 6. In certain embodiments, y in any of the structures herein is 7. In certain embodiments, y in any of the structures herein is 8. In certain embodiments, y in any of the structures herein is 9. In certain embodiments, y in any of the structures herein is 10. In certain embodiments, y in any of the structures herein is 11. In certain embodiments, y in any of the structures herein is 12.

In certain embodiments, y in any of the structures herein is an integer greater than 5. In certain embodiments, y in any of the structures herein is an integer greater than 6, greater than 7, greater than 9, or greater than 10. In certain embodiments, y in any of the structures herein is an integer between 10 and 20.

In certain embodiments, provided ascaroside compositions comprise a mixture of ascarosides varying only in the value of y (i.e. the composition comprises a mixture of congeners with varying sidechain lengths). In certain embodiments, such compositions are characterized in that the average value of y in the composition is between about 2 and about 20. ). In certain embodiments, such compositions are characterized in that the average value of y in the composition is between about 3 and about 10, between about 4 and about 12, between about 6 and about 10, or between about 7 and about 9. In certain embodiments, such compositions are characterized in that the average value of y in the composition is greater than about 4, greater than about 5, greater than about 6, greater than about 7, or greater than about 8. The average value of y in such compositions can be determined by various methods well known in the art including, but not limited to analyzing the mixture by ¹H NMR spectroscopy, mass spectroscopy, high performance liquid chromatography and the like.

In an embodiment, ascarosides useful in the context of the present disclosure have the general structure (I), where Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide, and can be used for inhibiting human pathogenic bacterial growth in or on a plant.

In an embodiment, ascarosides useful in the context of the present disclosure have the general structure (I) where Z is —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

Specific ascarosides that are useful in the context of the present disclosure include, but are not limited to, ascr #7 and ascr #18.

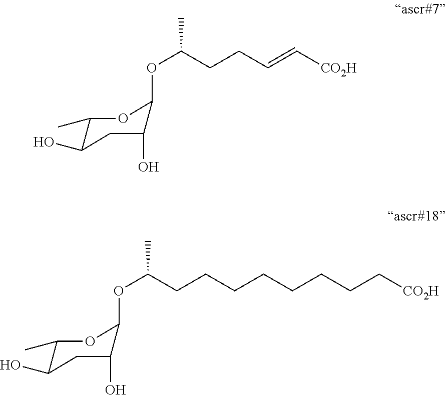 [SMILES: CC1OC(O[C@H](C)CC/C=C/C(=O)O)C(O)CC1O ; CC1OC(O[C@H](C)CCCCCCCCC(=O)O)C(O)CC1O]

In certain embodiments, an ascaroside used in the provided methods and compositions is selected from the group consisting of: ascr #9, ascr #12, ascr #14, ascr #1, ascr #10, ascr #16, ascr #18, ascr #20, ascr #22, ascr #24, ascr #26, ascr #28, ascr #30, ascr #32, ascr #34, and ascr #36. In certain embodiments, an ascaroside used in the provided methods is selected from the group consisting of: ascr #10, ascr #16, ascr #18, ascr #20, ascr #22, and ascr #24. In certain embodiments, an ascaroside used in the provided methods is selected from the group consisting of: ascr #9, ascr #14, ascr #10, and ascr #18.

In certain embodiments, an ascaroside used in the provided methods and compositions is selected from the group consisting of: ascr #5, oscr #9, oscr #12, oscr #1, oscr #14, oscr #10, oscr #16, oscr #18, oscr #20, oscr #22, oscr #24, oscr #26, oscr #28, oscr #30, oscr #32, oscr #34, and oscr #36. In certain embodiments, an ascaroside used in the provided methods is selected from the group consisting of: oscr #10, oscr #16, oscr #18, oscr #20, and oscr #22. In certain embodiments, an ascaroside used in the provided methods is selected from the group consisting of: bhas #5, oscr #9, oscr #12, oscr #1, oscr #14, oscr #10, oscr #16, oscr #18, oscr #20, oscr #22, oscr #24, oscr #26, oscr #28, oscr #30, oscr #32, oscr #34, and oscr #36. In certain embodiments, an ascaroside used in the provided methods is selected from the group consisting of: oscr #10, oscr #16, oscr #18, oscr #20, and oscr #22.

In certain embodiments, an ascaroside used in the provided methods and compositions is selected from the group consisting of: bhas #9, bhas #10, bhas #16, bhas #18, bhas #22, bhas #24, bhas #26, bhas #28, bhas #30, bhas #32, bhas #34, bhas #36, bhas #38, bhas #40, and bhas #42.

In certain embodiments, an ascaroside used in the provided methods and compositions is selected from the group consisting of: bhos #10, bhos #16, bhos #18, bhos #22, bhos #24, bhos #26, bhos #28, bhos #30, bhos #32, bhos #34, bhos #36, bhos #38, bhos #40, and bhos #42.

In certain embodiments, an ascaroside used in the provided methods and compositions is selected from the group consisting of: ascr #18, oscr #16, oscr #17, oscr #15, bhas #18, bhos #16, glas #18, dhas #18, ibha #18, ibho #16, icas #18, icos #15, icos #16, and any combination of two or more of these.

Ascarosides can be obtained from natural sources (e.g., nematodes) or they may be prepared synthetically. Ascarosides can be prepared synthetically, for example, by converting 1-O-substituted rhamnose to 1-O-substituted ascarylose. An exemplary method of preparing ascarosides includes: providing as a feedstock a 1-O-substituted rhamnose; forming a mono-sulfonate ester at the 3-OH group of the feedstock; and treating the mono-sulfonate ester with a hydride source to form a 1-O-substituted ascarylose. In certain embodiments, forming the mono-sulfonate ester is conducted on a substrate without hydroxyl protecting groups at the 2- or 4-position of the rhamnose feedstock. In certain embodiments, such methods comprise contacting the feedstock with a sulfonating agent (i.e., a sulfonyl halide, sulfonic anhydride or similar reagent) in the presence of a Lewis acid. Specific details regarding the synthesis of 1-O-substituted ascarylose can be found in PCT Application No. PCT/US2021/056981, which is incorporated herein by reference.

According to certain embodiments, microbial growth in and/or on plant-based products can be inhibited by treatment of the plant-based product with the ascarosides of structure (I).

The method by which the plant-based products are treated with an ascaroside are not particularly limited. They can be treated at any stage from pre-harvest to harvest to post-harvest. They can be treated with ascaroside formulated as a solid or via ascaroside formulated as a liquid (e.g., suspension, emulsion, or solution, e.g., aqueous solution). Formulations can consist/consist essentially of the ascaroside (e.g., along with a solvent or solvent/co-solvent mixture) or can comprise any number of additional components.

Prior to use, the ascarosides used in the compositions of the present disclosure may be dissolved in water to form an aqueous solution of the ascaroside. Some ascarosides, however, have limited solubility in water. Therefore, it may be necessary to initially dissolve the ascaroside in a co-solvent that is water miscible and acceptable for use in the plant-based products intended for human consumption. Various water-miscible solvents are known and can be used for this purpose. Preferred co-solvents include ethanol and propylene glycol. In an embodiment, a stock solution of the ascaroside dissolved in ethanol can be prepared. In an embodiment, a stock solution of the ascaroside dissolved in propylene glycol can be prepared. The stock solution is added to a suitable amount of water to prepare the aqueous solution of the ascaroside. As used herein, an “aqueous solution” includes solutions comprising primarily water as the solvent, optionally including one or more co-solvents in an amount up to about 45% by volume, up to about 40% by volume, up to about 35% by volume, up to about 30% by volume, up to about 25% by volume, up to about 20% by volume, up to about 15% by volume, up to about 10% by volume, up to about 5% by volume, up to about 1% by volume, or up to about 0.1% by volume.

In one embodiment, plant-based products can be treated with an ascaroside composition (e.g., an aqueous solution of one or more ascarosides) by soaking the plant-based product in the ascaroside composition. The plant-based product can be simply soaked or can be soaked with gentle agitation (e.g., as provided by circulation of the liquid via a pump or a rotary drum in which the plant-based product is contacted with the ascaroside solution). The plant-based products are soaked in the ascaroside solution for a time sufficient to allow ascarosides to enter into the product. Typically, the plant-based products are soaked for a time of about 1 min. to about 12 hours (e.g., about 5 min. to about 6 hours or about 30 min. to about 3 hours, or about 6 hours to about 12 hours), although such times are not intended to be limiting, and greater or lesser time ranges can, in some embodiments, be employed. In certain embodiments, the plant-based products are soaked in a solution containing one or more ascarosides for about 1 min., about 5 min., about 10 min., about 20 min., about 30 min., about 45 min., about 1 hour, about 2 hours, about 3 hours, about 4 hours, about 5 hours, about 6 hours, about 7 hours, about 8 hours, about 9 hours, about 10 hours, about 11 hours, or about 12 hours. In some embodiments, the plant-based products are washed with a solution containing one or more ascarosides. The during the washing process the plant-based products can be contacted with the ascaroside solution for up to about 0.5 seconds, up to about 1 second, up to about 5 seconds, up to about 10 seconds, up to about 30 seconds, or up to about 60 seconds.

Plant-based products can be soaked during harvesting or after harvesting. During harvesting, dump tanks (containers filled with water) can be used during collection of the plant-based products during harvesting. The water is used to simultaneously clean the plant-based products and inhibit bruising of the products. In an embodiment, the water in the dump tank includes one or more ascarosides. Alternatively, plant-based products can be placed into a container having a composition that includes one or more ascarosides after harvesting. The soaking can thus be conducted at various times following harvest, e.g., immediately upon harvest of a single item (e.g., by adding directly to a dump tank containing one or more ascarosides) or shortly after harvest (e.g., when the crop is removed from the fields (or greenhouses) in which they are grown and individual items can be transferred to a vessel containing a composition containing one or more ascarosides (or such a composition can be added to a vessel containing the harvested plant-based products)). After harvest, the timing may vary and the plant-based products can, in some embodiments, be treated within a short period of time after harvest (e.g., within 24 hours after harvest). In further embodiments, treatment may be delayed, such that the plant-based products are soaked at a later point, e.g., after being transported to a processing center or after being transported to a retail site.

The ascaroside solution, when used for soaking plant-based products, has an ascaroside concentration ranging from about 1 nM to about 1 mM. Exemplary concentrations of the ascaroside solution include 1 nM, 10 nM, 50 nM, 100 nM, 500 nM, 1 μM, 2 μM, 3 μM, 4 μM, 5 μM, and 10 μM. Exemplary ranges for the concentration of ascaroside in the ascaroside solution include 1 nm to 10 μM, 10 nM to 5 μM, 50 nM to 3 μM, and 100 nM to 1 μM. When the ascaroside solution includes more than one ascaroside, the phrase “ascaroside concentration” refers to the total concentration of all ascarosides in the solution.

In one embodiment, plant-based products may be treated with an ascaroside coating formulation (e.g., a liquid or powder composition containing one or more ascarosides) via spray methods. Such spray methods can be done pre-harvest (e.g., within about a week or a within a day or two before harvesting), during harvest, or post-harvest (up to 6 weeks after harvesting).

Pre-harvest, the ascaroside coating formulation can be applied to plant-based products before the products are ready for harvesting. For example, an ascaroside coating formulation can be applied to plant-based products shortly after the products appear on the associated plants or tress. Alternatively, or in addition, the ascaroside coating formulation can be applied to the plants or trees which produce the plant-based products before the products begin to grow. Applying the ascaroside coating formulation to plants that produce the plant-based product scan impart protection against microbes on the plants. This protection can also be further imparted to the plant-based products that are obtained from the treated plants.

In some embodiments, plant-based products can be passed through a sprayer with a composition containing one or more ascarosides as they are harvested; they may be contacted with a spray or a composition containing one or more ascarosides after they are removed from the fields (or greenhouses) in which they are grown. After harvest, the timing may vary and, in some embodiments, the plant-based products can be sprayed within a short period of time after harvest (e.g., within 24 hours after harvest). In further embodiments, treatment may be delayed, such that the plant-based products are sprayed at a later point, e.g., after being transported to a processing center or after being transported to a retail site. In still further embodiments, the plant-based products may be sprayed, e.g., via a mister at the point of sale (e.g., on a continuous/regularly timed basis). Again, the plant-based products can remain largely stationary during such spray treatment methods or can be agitated.

Plant-based product coating can be achieved by any known means for spraying the composition onto the plant-based products. In contrast to soaking, spray methods generally use a smaller (e.g., minimum) amount of liquid to provide protected products that are stable to storage and transport. The ascaroside solution used to spray the plant-based products has a concentration that ranges from about 1 ppb up to about 500 ppm. For example, the concentration of ascaroside used for spray treatment of plant-based products may be 1 ppb, 10 ppb, 50 ppb, 100 ppb, 250 ppb, 500 ppb, 1 ppm, 2 ppm, 3 ppm, 5 ppm, 10 ppm, 15 ppm, 20 ppm, 25 ppm, 30 ppm, 40 ppm, 50 ppm, 100 ppm, 200 ppm or 500 ppm.

The soaking and spraying methods provided herein are not intended to be limiting. Rather, any method for bringing the plant-based products into contact with an ascaroside (in solid or liquid, e.g., solution) form can be employed and is intended to be encompassed by the present disclosure. For example, in some embodiments, a wrapper, sticker or adhesive can be treated or formulated so as to comprise an ascaroside, and then brought into contact with the plant-based products to be treated, e.g., by applying the wrapper or sticker to the individual products. In some embodiments, coatings are regularly applied to certain plant-based products and an ascaroside can be incorporated within such coatings. As one example, edible waxes and oils are commonly applied to fruits such as apples, citrus fruits, and root vegetables and an ascaroside can be applied thereto, e.g., via incorporating an ascaroside within the wax or oil formulation.

In an embodiment, provided methods include continuously contacting the plant-based material with a composition comprising one or more ascarosides during or more of shipping, marketing or during use by a consumer. For example, by keeping the stems of cut flowers, decorative foliage or fresh herbs submersed in a solution containing ascaroside, or by keeping the stems or other parts of cut flowers, decorative foliage or fresh herbs in contact with an absorptive material moistened with a solution containing ascarosides. In another embodiment, an ascaroside composition may be provided packaged for sale along with decorative plant material and intended for use by the consumer, for example to be used by adding the ascaroside composition to vase water. In certain embodiments, the ascaroside can be incorporated into a nutrient composition containing sugar or similar materials commonly provided with bouquets and intended to be added to vase water to make cut flowers and foliage last longer.

Prior to use, the ascarosides used in the compositions of the present disclosure may be blended with other materials for application to plant materials. Examples include waxes, oils, latexes, shellac, polymer films, adhesives or coatings that coated onto or placed in contact with the produce to enhance appearance, prolong shelf-life, control moisture loss, adhere labels etc. In certain embodiments, methods provided herein may include adding ascarosides to such compositions or formulations. If the ascaroside is not directly soluble in or miscible with such formulations, it may be necessary to initially dissolve the ascaroside in a co-solvent that is miscible with the formulation and acceptable for use in the plant-based products intended for human consumption. Various food-safe solvents are known and can be used for this purpose. Preferred co-solvents include ethanol and propylene glycol. In an embodiment, a stock solution of the ascaroside dissolved in ethanol can be prepared. In an embodiment, a stock solution of the ascaroside dissolved in propylene glycol can be prepared. The stock solution is added to a suitable amount of coating formulation to prepare the ascaroside-containing formulation. In an embodiment, a mixture of one or more ascarosides in a food safe oil is provided. In an embodiment, a mixture of one or more ascarosides in a food safe wax is provided. In an embodiment, a mixture of one or more ascarosides in a food safe adhesive is provided. In an embodiment, a mixture of one or more ascarosides in a food safe paint or colorant is provided.

According to the present disclosure, plant-based product treatments are applied at rates to provide treated plant-based products having from about 0.0001 ppm to about 100 ppm ascaroside content by weight. In certain embodiments, such plant-based products are treated so as to contain from about 0.001 to about 10 ppm ascarosides. In certain embodiments, such fruits or vegetables are treated so as to contain from about 0.01 to about 1 ppm ascarosides. In certain embodiments, such fruits or vegetables are treated so as to contain from about 0.1 to about 5 ppm ascarosides. In certain embodiments, such fruits or vegetables are treated so as to contain from about 0.0001 to about 0.001 ppm ascarosides. In certain embodiments, such fruits or vegetables are treated so as to contain from about 0.001 to about 0.01 ppm ascarosides. In certain embodiments, such fruits or vegetables are treated so as to contain from about 0.01 to about 0.1 ppm ascarosides. In certain embodiments, such plant-based products contain from about 0.2 to about 5 ppm ascarosides. In certain embodiments, such plant-based products contain from about 1 to about 10 ppm ascarosides. In certain embodiments, such plant-based products contain from about 2 to about 5 ppm ascarosides. In certain embodiments, such plant-based products contain from about 0.1 to about 1 ppm ascarosides. In certain embodiments, such plant-based products contain from about 0.5 to about 2.5 ppm ascarosides. In certain embodiments, the method includes treating plant-based products, drying the plant-based products, storing the plant-based products, and optionally transporting the plant-based products to a retail site. In some embodiments, such ascaroside effects are exhibited in the plant-based products immediately after treatment and may persist for a given period of time after treatment, e.g., at least about 1 day, at least about 2 days, at least about 3 days, at least about 4 days, at least about 5 days, at least about 6 days, at least about 1 week, at least about 2 weeks, at least about 3 weeks, or at least about 4 weeks.

In an embodiment of the present disclosure, it has been found that contacting plant-based products with an ascaroside solution can inhibit the proliferation of microbes in and/or on the products. In some embodiments, such inhibition can provide for longer shelf life associated with the treated plant-based products. While not wishing to be held to any particular theory, it is believed that the protective effects of treatment with ascarosides results from the upregulation of plant defense genes by the presence of the ascarosides.

Biofilm formation represents one of the major defense strategies employed by bacteria against hostile environmental conditions. Biofilm formation by bacteria on the exterior or interior of plant-based products can provide a protected environment where pathogenic bacteria can colonize and thrive. While not being bound to any particular theory, it is believed that that ascarosides can affect bacteria's ability to form biofilms. By disrupting biofilm formation, ascarosides can remove one of the bacteria's primary defense mechanisms.

A variety of human pathogenic bacteria can be controlled by the treatment of plant-based products with an ascaroside solution. Examples of bacteria that can be controlled include, but are not limited to, Salmonella enterica, Salmonella serovar Muenchen, Salmonella Saintpaul, Escherichia coli O157:H7, Escherichia coli O157:NM, Escherichia coli O121, Escherichia coli O0104:H4, and Listeria monocytogenes.

It is theorized that the plant-based products uptake about 0.01 to about 100 ppm of the ascarosides after soaking in the ascaroside solution. The amount of uptake of ascaroside in the plant-based products is a function, e.g., of the concentration of ascarosides in the ascaroside solution, the time of soaking, and the type of produce. The amount of ascaroside that is present in the treated plant-based products can therefore be modified by adjusting these parameters. Typically, plant-based products are treated with the ascaroside (e.g., the ascaroside solution) at ambient temperature and pressure. In some embodiments, plant-based products are treated with the ascaroside (e.g., the ascaroside solution) that is at a temperature and/or pressure that is higher than ambient temperature and/or pressure. Treatment of plant-based products at a temperature and/or pressure that is higher than ambient temperature and/or pressure can kill some or all human pathogenic bacteria that may be present in and/or on the plant-based products.

The plant-based product treatments as provided herein have been shown to reduce or prevent microbe contamination without the need for additional types of treatment. While the plant-based products treatment as provided herein can be the only microbe reducing treatment conducted, in other embodiments, these treatments can be used in tandem with one or more known methods for reducing or eliminating microbes including, but not limited to, treatment with acidic electrolyzed water, ozonated water, chlorine dioxide, trisodium phosphate, calcium hypochlorite (bleaching powder), and sodium hypochlorite (bleach).

According to the present disclosure, shelf life of a plant-based product can be prolonged by contacting the product with a composition comprising an ascaroside after the product has been harvested. The harvested product can be treated with the ascaroside composition. Treatment of the harvested product with an ascaroside composition increases the shelf life of the ascaroside treated product, compared to the corresponding untreated vegetable.

Embodiments of the invention include:
1. A method of inhibiting the proliferation of microbial growth in and/or on plant-based products, comprising treating the plant-based products with a composition comprising one or more ascarosides.
2. The method of embodiment 1, wherein the microbial growth that is inhibited is human pathogenic microbial growth.
3. The method of embodiment 1, wherein the microbial growth that is inhibited is enteric pathogens.
4. The method of embodiment 1, wherein the microbial growth that is inhibited is bacterial growth.
5. The method of embodiment 1, wherein the microbial growth that is inhibited is fungal growth.
6. The method of embodiment 1, wherein the microbes belong to a genera selected from the group consisting of Salmonella, Listeria, and Escherichia, Clostridium and Campylobacter.
7. The method of embodiment 1, wherein the microbial growth that is inhibited is microbial growth associated with spoilage of the plant-based products.
8. The method of embodiment 1, wherein the microbes comprise mold.
9. A method of extending the shelf life of plant-based products, comprising contacting the plant-based products with a composition comprising one or more ascarosides.
10. The method of any preceding embodiment, wherein the plant-based products are vegetables.
11. The method of embodiment 10, wherein the vegetables are selected from the group consisting of stem-based vegetables, leaf-based vegetables, flower-based vegetables, roots/tuber-based vegetables, bulb-based vegetables, fruit-based vegetables, and seed-based vegetables.
12. The method of any one of embodiments 1 to 9, wherein the plant-based products are fruits.
13. The method of embodiment 12, wherein the fruits are selected from the group consisting of berries, citrus fruits, drupes, pomes, melons, and tropical fruit.
14. The method of any preceding embodiment, wherein the one or more ascarosides have the structure (I)

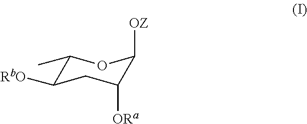

where:
Z is an optionally substituted C₂₋₁₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. —a moiety —C(O)OR^{c}), a C₂₋₂₀ carbamate (e.g. —a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule. Where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.
15. The method of embodiment 14, wherein Z is selected from the group consisting of.
   (i) —CH(CH₃)—R¹, where R¹ is an optionally substituted C₁₋₄₀ aliphatic group;
   (ii) —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
   (iii) —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
   (iv) —CH(CH₃)—(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
   (v) —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
   (vi) —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
   (vii) —(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
   (viii) —(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; and
   (ix) —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule.
16. The method of embodiment 14, wherein Z is selected from the group consisting of.
   (x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xii) —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiii) —CH(CH₃)—(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xvi) —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
   (xvii) —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.
17. The method of any one of embodiments 14 to 16, wherein R^{a} and R^{b} are each —H.
18. The method of any one of embodiments 14 to 17, wherein Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
19. The method of embodiment 18, wherein at least one of the one or more ascarosides is ascr #18.
20. The method of any one of embodiments 14 to 17, wherein Z is —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
21. The method of embodiment 20, wherein at least one of the one or more ascarosides is ascr #7.
22. The method of any one of embodiments 1 to 21, wherein the composition comprising one or more ascarosides is an aqueous composition.
23. The method of any one of embodiments 1 to 22, wherein the plant-based products are treated by soaking the plant-based products in the composition comprising one or more ascarosides.
24. The method of embodiment 23, wherein the plant-based products are soaked in a tank comprising the composition comprising one or more ascarosides during harvesting of a crop of the plant-based products.
25. The method of any one of embodiments 23 or 24, wherein the plant-based products are soaked in the composition for a time of about 1 min to about 6 hours.
26. The method of any one of embodiments 1 to 22, wherein the plant-based products are treated by spraying the plant-based products with the composition comprising one or more ascarosides.
27. The method of any one of embodiments 1 to 26, wherein a concentration of the one or more ascarosides in the composition is about 1 ppb to about 50 ppm.
28. A plant-based product protected from microbial growth by treating the plant-based product with the method according to any one of embodiments 1 to 27.
29. A plant-based product that has been treated according to the method of any one of embodiments 1 to 27, wherein the treated plant-based product has a shelf life substantially longer than the corresponding untreated plant-based product.

### EXAMPLES

The following examples embody certain methods of the present invention and are not intended to be limiting.

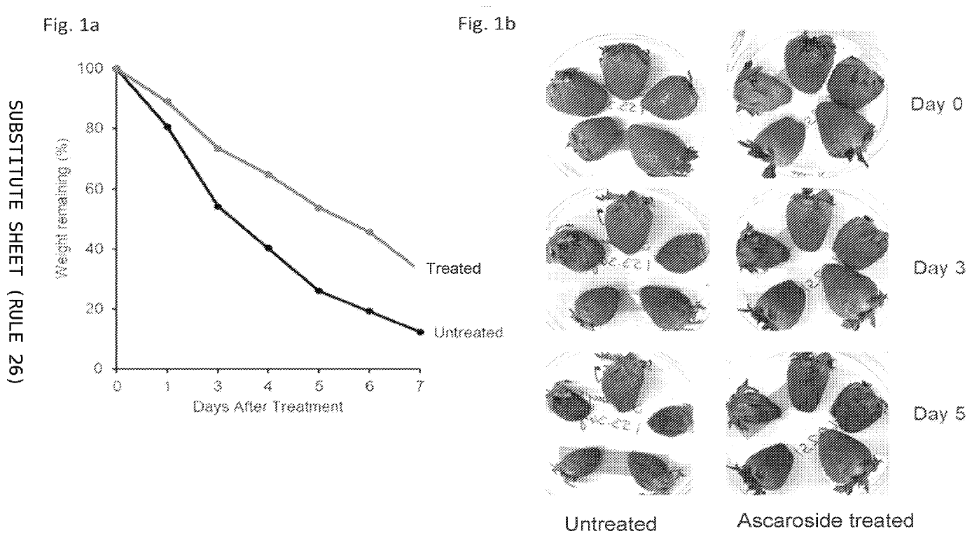

Example 1: treatment of fruit with ascarosides extends shelf-life/delays spoilage. Store-bought Strawberries were treated with ascaroside (ascr #18) by dipping the berries into a 100 nM water solution of the ascaroside or a mock solution lacking ascaroside. Five berries from each treatment group were placed in glass dishes and left uncovered on a table indoors at ambient temperature and monitored for one week. Fruit weight was measured at 0, 1, 3, 4, 5, 6, and 7 days post-treatment. A plot of the normalized mass of the two treatment groups over the seven days is shown in FIG. 1a. The ascaroside treated berries retained approximately 25% more of their original mass than the untreated group indicating a reduced spoilage rate and potential for increased shelf life. FIG. 1b shows photographs of the two treatment groups taken 0, 3, and 5 days post-treatment. While both treatment groups spoiled over the course of the experiment, it is qualitatively apparent that the treated fruit maintained higher quality than the untreated fruit. Similar results were obtained by treating fruits by spraying the ascaroside solution onto the fruit. Example 2: treatment of fruit with coating compositions containing ascarosides. Freshly harvested, non-coated, apples were obtained from a supermarket. These were washed and experimental coatings were applied.

The experimental coatings were formulated as follows:
Polyethylene: 18.6% oxidized polyethylene (AC680 from Allied Signal, Inc., Morristown, NJ), 3.4% food-grade oleic acid (Emersol 6321, Henkel. Cincinnati, OH), 2.8% morpholine, 0.01% polydimethylsiloxane antifoam (SE21, Wacker Silicones Co., Adrian, MI), with the balance being either water (control) or a 1 uM aqueous solution of ascr #18 (ascaroside treated).
Candelilla coating: 18.3% candelilla wax (SP 75, Strahl & Pitsch, Inc., West Babylon, NY), 2.1% oleic acid, 2.4% morpholine, 0.02% polydimethylsiloxane antifoam with the balance being either water (control) or a 1 uM aqueous solution of ascr #18.
Camauba-shellac coating: 9.5% shellac (R52, Mantrose Haeuser Co., Attleboro, MA), 8.3% carnauba wax (No. 1, Strahl & Pitsch, Inc.), 3.3% morpholine, 1.7% oleic acid, 0.17% NH₃, 0.01% polydimethyl-siloxane antifoam. with the balance being either water (control) or a 1 uM aqueous solution of ascr #18..
Shellac coating: 19% shellac, 1.0% oleic acid, 4.4% morpholine, 0.3% NH₃, 0.01% polydimethylsiloxane antifoam with the balance being either water (control) or a 1 uM aqueous solution of ascr #18.
Shellac-WPI coating: 13.3% shellac, 3.0% whey protein isolate (BiPRO, Davisco Foods International, Inc., Le Sueur, MN), 3.1% morpholine, 0.7% oleic acid, 0.2% NH₃, 0.01% polydimethylsiloxane anti-foam with the balance being either water (control) or a 1 uM aqueous solution of ascr #18 (ascaroside treated).

For coating application, 1.0 ml aliquots of each coating is spread evenly over each apple surface using latex-gloved hands. The effective amount of applied material is 0.6 g per apple. Groups of 60 fruit are treated with each of the formulations described above. A pilot-plant scale conveyor dryer is used to dry fruit (including controls) at 50 C for 5 min. After application of the coatings the apples are stored at 20 C and approximately 70% relative humidity for 4 weeks.

Gloss, weight loss, and flesh firmness were measured on 20 individual fruit per treatment. Internal O₂, CO₂ and ethylene are determined using five individual fruit for each treatment. Measurements are conducted initially, and following storage for 2 and 4 weeks at 20 C. Initial measurements are taken 1 day after coating, to allow the fruit to recover from the hot air drying process, and to allow coatings to completely dry.

It is contemplated that compositions, systems, devices, methods, and processes of the present application encompass variations and adaptations developed using information from the embodiments described in the present disclosure. Adaptation or modification of the methods and processes described in this specification may be performed by those of ordinary skill in the relevant art.

It will be appreciated that use of headers in the present disclosure are provided for the convenience of the reader. The presence and/or placement of a header is not intended to limit the scope of the subject matter described herein. Unless otherwise specified, embodiments located in one section of the application apply throughout the application to other embodiments, both singly and in combination.

Throughout the description, where compositions, compounds, or products are described as having, including, or comprising specific components, or where processes and methods are described as having, including, or comprising specific steps, it is contemplated that, additionally, there are articles, devices, and systems of the present application that consist essentially of, or consist of, the recited components, and that there are processes and methods according to the present application that consist essentially of, or consist of, the recited processing steps.

It should be understood that the order of steps or order for performing certain action is immaterial so long as the described method remains operable. Moreover, two or more steps or actions may be conducted simultaneously.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

What is claimed is:

1. A method of inhibiting the proliferation of microbial growth in and/or on plant-based products, comprising treating the plant-based products with a composition comprising one or more ascarosides.

2. The method of claim 1, wherein the microbial growth that is inhibited is human pathogenic microbial growth.

3. The method of claim 1, wherein the microbial growth that is inhibited is enteric pathogens.

4. The method of claim 1, wherein the microbial growth that is inhibited is bacterial growth.

5. The method of claim 1, wherein the microbial growth that is inhibited is fungal growth.

6. The method of claim 1, wherein the microbes belong to a genera selected from the group consisting of Salmonella, Listeria, and Escherichia, Clostridium and Campylobacter.

7. The method of claim 1, wherein the microbial growth that is inhibited is microbial growth associated with spoilage of the plant-based products.

8. The method of claim 1, wherein the microbes comprise mold.

9. A method of extending the shelf life of plant-based products, comprising contacting the plant-based products with a composition comprising one or more ascarosides.

10. The method of any preceding claim, wherein the plant-based products are vegetables.

11. The method of claim 10, wherein the vegetables are selected from the group consisting of stem-based vegetables, leaf-based vegetables, flower-based vegetables, roots/tuber-based vegetables, bulb-based vegetables, fruit-based vegetables, and seed-based vegetables.

12. The method of any one of claims 1 to 9, wherein the plant-based products are fruits.

13. The method of claim 12, wherein the fruits are selected from the group consisting of berries, citrus fruits, drupes, pomes, melons, and tropical fruit.

14. The method of any preceding claim, wherein the one or more ascarosides have the structure (I) 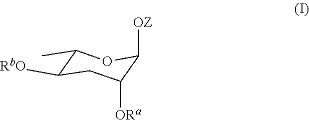
where:
Z is an optionally substituted C₂₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. —a moiety —C(O)OR^{c}), a C₂₋₂₀ carbamate (e.g. —a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R)₂), a sugar moiety, a peptide, a polymer chain, or a linkage via a bond or a carbon-containing linker moiety to another ascaroside molecule. Where R^{o} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

15. The method of claim 14, wherein Z is selected from the group consisting of:
(i) —CH(CH₃)—R¹, where R¹ is an optionally substituted C₁₋₄₀ aliphatic group;
(ii) —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iii) CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iv) —CH(CH₃)—(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(v) —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vi) —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vii) —(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(viii) —(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; and
(ix) —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule.

16. The method of claim 14, wherein Z is selected from the group consisting of
(x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xii) —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiii) —CH(CH₃)—(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xvi) —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
(xvii) —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.

17. The method of any one of claims 14 to 16, wherein R^{a} and R^{b} are each —H.

18. The method of any one of claims 14 to 17, wherein Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

19. The method of claim 18, wherein at least one of the one or more ascarosides is ascr #18.

20. The method of any one of claims 14 to 17, wherein Z is —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

21. The method of claim 20, wherein at least one of the one or more ascarosides is ascr #7.

22. The method of any one of claims 1 to 21, wherein the composition comprising one or more ascarosides is an aqueous composition.

23. The method of any one of claims 1 to 22, wherein the plant-based products are treated by soaking the plant-based products in the composition comprising one or more ascarosides.

24. The method of claim 23, wherein the plant-based products are soaked in a tank comprising the composition comprising one or more ascarosides during harvesting of a crop of the plant-based products.

25. The method of any one of claims 23 or 24, wherein the plant-based products are soaked in the composition for a time of about 1 min to about 6 hours.

26. The method of any one of claims 1 to 22, wherein the plant-based products are treated by spraying the plant-based products with the composition comprising one or more ascarosides.

27. The method of any one of claims 1 to 26, wherein a concentration of the one or more ascarosides in the composition is about 1 ppb to about 50 ppm.

28. A plant-based product protected from microbial growth by treating the plant-based product with the method according to any one of claims 1 to 27.

29. A plant-based product that has been treated according to the method of any one of claims 1 to 27, wherein the treated plant-based product has a shelf life substantially longer than the corresponding untreated plant-based product.
